(19) United States
(12) Patent Application Publication
(10) Pub. No.: US 2002/0186824 A1
(43) Pub. Date: Dec. 12, 2002

(54) Splitterless, transformerless, voice service independent ADSL interface

(76) Inventors: Constantine Sabodash, Plano, TX (US); Mark A. Bolla, Richardson, TX (US); Serdar Kiykioglu, Plano, TX (US)

Correspondence Address: FENWICK & WEST LLP, TWO PALO ALTO SQUARE, PALO ALTO, CA, 94306, US

(21) Appl. No.: 10/138,197

(22) Filed: May 1, 2002

Related U.S. Application Data
(63) Continuation-in-part of application No. 09/570,804, filed on May 15, 2000.
(60) Provisional application No. 60/337,106, filed on Dec. 6, 2001.
(60) Provisional application No. 60/339,950, filed on Dec. 10, 2001.

(51) Int. Cl. H04M 11/00

(52) U.S. Cl. 379/93.05

(57) ABSTRACT

Central office interface techniques for an application having no bulky splitter and no DSL coupling transformer are disclosed. No modification to the existing voice configuration (e.g., POTS) is required for deployment.

### RELATED APPLICATIONS

This application claims the benefit of U.S. Provisional Applications No. 60/337,106, filed Dec. 6, 2001, and No. 60/339,950, filed Dec. 10, 2001. In addition, this application is a continuation-in-part of U.S. application Ser. No. 09/570,804, filed May 15, 2000. Each of these applications is herein incorporated in its entirety by reference.

### FIELD OF THE INVENTION

The invention relates to telecommunications, and more particularly, to a digital subscriber line and voice interface between a telephone line and central office equipment of a network operator providing voice and digital subscriber line data services.

### BACKGROUND OF THE INVENTION

Existing communication infrastructure (e.g., copper twisted pair telephone lines) historically used for providing Plain Old Telephone Service (POTS) is also used in providing ADSL (Asymmetric Digital Subscriber Line) service to consumers. As such, a special communication medium for ADSL in not required. However, the signals that are required for POTS and ADSL are very different and cannot interfere with each other in any perceptible way. In order to accomplish transmission of POTS and ADSL data on the same twisted pair, therefore, a “splitter” is used to separate the signals both at the central office (CO) and at the customer premises. Specifically, the splitter is used to separate the high frequency ADSL band (e.g., 25 kHz to 1.1 MHz) from the low frequency POTS band (e.g., 300 Hz to 4000 Hz).

The splitter itself is typically a combination of a high pass and a low pass filter that separates the two frequency bands so that the signals are passed to the appropriate sections. The data of the lower frequency band is provided to the POTS section along with the POTS signaling voltage components (e.g., battery voltage and high voltage ringing), while the data of the high frequency band is passed to the ADSL section. The problem with this discreet type of implementation is that the parts used to implement the splitter are usually bulky and expensive.

Another similarly costly and bulky component is the DSL coupling transformer, which provides a balanced interface for coupling the transmission line to DSL circuitry, matching the transceiver impedance to the DSL line impedance. As space is limited (e.g., at the central office), there is generally an increasing demand in the market place for interface solutions that reduce the area necessary for deployment. However, any modifications to the interface in efforts to reduce the bulk of the splitter and coupling transformer that impact the transmission characteristics (e.g., structural impedances and insertion loss of the splitter filters in the high and low pass signal paths) of the POTS and DSL equipment must be taken into consideration.

What is needed, therefore, are techniques for eliminating the bulky splitter given a transformerless ADSL line interface.

### BRIEF SUMMARY OF THE INVENTION

Embodiments of the present invention can operate in an application having no bulky splitter and no DSL coupling transformer. A significant density improvement is thus realized. In addition, the disclosed techniques operate with the existing voice configuration without requiring modification.

One embodiment of the present invention provides a system for interfacing a telephone line with a central office. The system includes an “any voice circuit” that is generally configured to process voice signals. An in-line filter is adapted to couple with to a data path between the telephone line and the any voice circuit. This in-line filter includes a capacitor that is coupled across the two-wire interface of the any voice circuit (e.g. POTS circuit), and rejects signals having frequencies above the voice frequency band. The system further includes a DSL circuit that is adapted to couple to the telephone line, and for processing DSL signals (e.g., ADSL data).

The DSL circuit includes a transmit path line driver that is configured with a frequency variant impedance synthesis network. This network allows the line driver to actively synthesize a DSL termination impedance that increases in magnitude with decreasing frequency. At DSL band frequencies, the synthesized DSL termination impedance is under 200 ohms (e.g., approximately 100 ohms or other industry compliant DSL termination impedance). However, at voice band frequencies (e.g., such as the POTS band) the synthesized DSL termination impedance is relatively high (e.g., greater than 1 kohm). This relatively high termination impedance reduces the shunting effect of the DSL two-wire impedance on the any voice two-wire impedance, improves the return loss characteristics, and enables a better frequency response.

Another embodiment of the present invention provides a transmit path DSL line driver device that is configured to actively synthesize a desired termination impedance. This device can be used, for example, in a central office application that has no bulky splitter and no DSL coupling transformer. The device includes a first operational amplifier for driving transmit signals on a first wire pair included in a 4-wire interface, and a second operational amplifier for driving transmit signals on a second wire pair included in the 4-wire interface. Thus, the line driver is configured to operatively couple with, for example, a 2-to-4 wire hybrid interface of a DSL circuit for processing DSL signals.

Each of the first and second operational amplifiers is configured with a frequency variant impedance synthesis network including one or more feedbacks that allow the line driver to actively synthesize a DSL termination impedance. This DSL termination impedance is greater than 1 kohm at voice band frequencies and less than 200 ohms at DSL band frequencies, and enables both the voice and DSL structural impedances to meet industry standard values. The line driver may be configured in a number of different ways. For example, in one embodiment, one or more negative feedback filters determine the frequency boundaries of the synthesized DSL termination impedance. A positive feedback filter can then be used to compensate for the phase characteristics of the negative feedback filters. In an alternative embodiment, only a positive feedback filter is employed, and each of the first and second operational amplifiers can be configured with a high pass filter on its input, the high pass filter for preventing overload of the DSL receive ports of the line driver. Other embodiments are illustrated and described herein.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram illustrating a central office interface between a telephone line and voice and ADSL circuitry in accordance with one embodiment of the present invention.

FIG. 2 is a block diagram illustrating the topology of an ADSL line driver and an in-line POTS band filter in accordance with an embodiment of the present invention.

FIG. 3 is a schematic diagram illustrating a high pass filter for the ADSL band in accordance with one embodiment of the present invention.

FIG. 4a is a schematic diagram illustrating a line driver and an in-line filter in accordance with an embodiment of the present invention.

FIG. 4b is a schematic diagram illustrating a line driver and an in-line filter in accordance with another embodiment of the present invention.

FIG. 5 is a schematic diagram illustrating a line driver and an in-line filter in accordance with another embodiment of the present invention.

FIG. 6 is a schematic diagram illustrating a line driver and an in-line filter in accordance with another embodiment of the present invention.

### DETAILED DESCRIPTION OF THE INVENTION

POTS service provided by the CO requires that the CO present an electronic termination that looks like a 900 ohm resistor in series with a 2.16 microfarad capacitor. This termination will provide a proper return loss to the customer premises equipment (CPE) across the subscriber loop. A mismatch in this termination causes signal reflection, loss of signal power delivered to the load, and objectionable echo (depending on factors such as the distance from the CO). On the other hand, ADSL requires that the terminating impedance be a “real” resistance of approximately 100 ohms, which maximizes signal power transfer to the load and achieves the greatest data rate and distance. Modifications to the conventional bulky splitter or the coupling transformer generally affect these respective structural impedances.

Embodiments of the present invention provide a transformerless central office interface that is configured to separate high frequency ADSL and low frequency POTS signals without using a conventional bulky splitter, while presenting the appropriate terminating impedances to the POTS and ADSL sections. Thus, space and cost savings are achieved with out sacrificing optimal sound quality, data rate or transmission characteristics.

General Overview

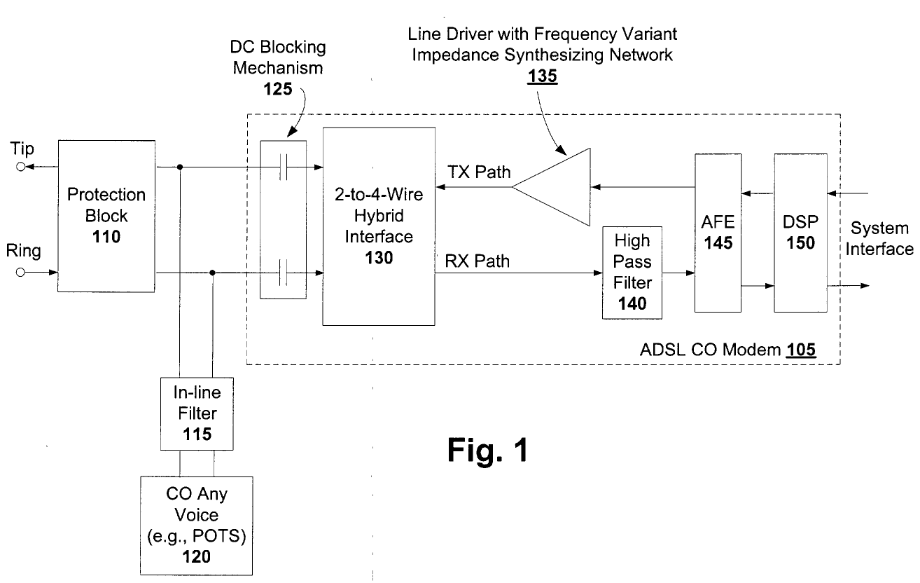

FIG. 1 is a block diagram illustrating an interface in accordance with one embodiment of the present invention. As can be seen, the interface is between a telephone line (tip and ring) and central office equipment of a network operator providing voice and digital subscriber line data services. The interface, which is splitterless, has no DSL coupling transformer and is independent of the particular voice circuitry employed. An any voice circuit 120 is included for processing voice band signals, and a DSL circuit 105 is included for processing DSL band signals. For purposes of discussion, assume that circuit 120 is an any POTS circuit 120. Note, however, that the principles of the present invention will operate with other voice circuits as well, and can be used to provide the required standard transmission characteristics. Generally, the interface provides the following performance goals:

Blocks the wideband ICN from the POTS band which may interfere with data in the ADSL band and impact ADSL performance;

Blocks ADSL signals from disturbing POTS operation;

Prevents signal overload by maintaining the POTS band signal coupling to the ADSL receive path below the maximum ADSL receive path dynamic range;

Maintains the CO POTS structural impedance of 900 ohms in series with 2.16 uF within the POTS band;

Maintains ADSL structural impedance of approximately 100 ohms within the ADSL band;

Maintains the POTS and ADSL longitudinal balance without any adverse impact on ADSL; and

Maintains the same or similar insertion loss of an existing conventional POTS plus DSL communication link.

The interface illustrated in FIG. 1 includes a protection block 110 that is coupled to the transmission line (e.g., tip and ring), and an in-line filter 115 that couples with any voice circuit 120. In the illustrated embodiment, the circuit 120 is an any POTS circuit 120. Generally, the any POTS 120 processes POTS frequency band signals in a conventional manner. Also included in the interface is an ADSL modem 105, which includes a DC blocking mechanism 125, a two-to-four wire hybrid interface 130, a line driver 135, a high pass filter 140, an analog front end (AFE) 145, and a digital signal processor (DSP) 150 that is coupled to a system interface (e.g., telephone company's network).

Variations on this example embodiment, such as having the DC blocking mechanism 125 or the DSP 150 external to the ADSL modem 105, or integrating high pass filter 140 into AFE 145, will be apparent in light of this disclosure. Further note that other circuitry not shown in FIG. 1 may also be included, such as ringing circuitry or an echo canceller. In addition, mechanisms for providing electrical isolation (e.g., for electrically isolating the analog front-end from the digital signal processor, and for electrically isolating the power source from the modules being powered) can also be included.

Protection Block

The protection block 110 effects a conventional protection scheme that may include, for example, an in-line fuse for protecting against power-cross, and diodes for providing protection against high voltage surges. Other protection mechanisms may also be included. For example, modem 105 can be configured with a digital isolation means for electrically isolating the AFE 145 from the DSP 150, and a power isolation means can be provided for electrically isolating the modem 105 power source (e.g., included in system interface) from the components being powered, such as the line driver 135, AFE 145, and DSP 150. Such digital and power isolation means are described in application Ser. No. 09/703,324, “Electrical Isolation Techniques in a DSL Modem,” which is herein incorporated by reference in its entirety.

In-line Filter of POTS Signal Path—ADSL to POTS Attenuation

The performance of any POTS 120 can be adversely affected by non-POTS band signals (e.g., ADSL signals). In order to remove the effects of these signals, the in-line filter 115, which rejects signals having frequencies above the POTS band, is placed in series with the signal path coupled to the two-wire interface of the any POTS 120 (e.g., POTS line card).

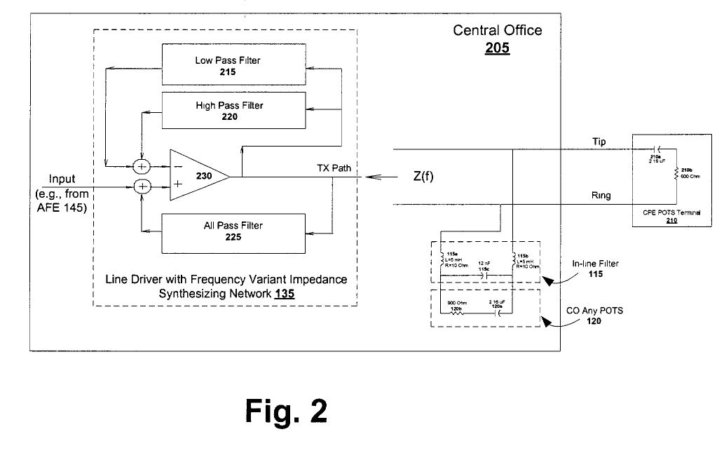

One embodiment of this in-line filter 115 is illustrated in FIG. 2, which includes two series inductors (115a and b) and a parallel capacitor (115c). This filter configuration is similar to that described in application Ser. No. 09/570,804, where the two-wire interface of the POTS circuit is coupled across a capacitor, which is coupled between the line side windings of the DSL coupling transformer. The in-line filter 115 effectively reduces and shunts the high frequency ADSL signals (or other non-POTS band signals) from affecting the performance of any POTS circuit 120. Note that at higher frequencies (above the POTS band), the parallel capacitor 115c effectively acts as a short-circuit across the two-wire interface of the any POTS circuit 120. Further-note that the values of inductors 115a and b and capacitor 115c are selected so as to not disturb the POTS band structural impedance.

DC Blocking Mechanism

The DC blocking mechanism 125 for the embodiment illustrated in FIG. 1 is provided by two capacitors, which isolate the modem 105 circuitry from ringing voltages and other direct current (DC) or low frequency signals. The values of the DC blocking capacitors 125 take into account that there is no splitter in this configuration. More specifically, in an application having a splitter, the capacitors of the splitter in series with such DC blocking capacitors provide a standards compliant capacitance to the loop. Here, however, the splitter has been eliminated. Thus, the value of the capacitors is adjusted accordingly. In one embodiment, the two series capacitors (one per lead) provide a total capacitance of approximately 33 nanofarads, +/−20% as measured at the tip and ring interface of the telephone line.

2-to-4-Wire Interface, AFE and DSP

The 2-to-4-wire hybrid interface 130 performs 2-to-4-wire conversion, which converts the bi-directional two-wire signal from the tip and ring leads of the telephone line into two pairs of one-directional transmissions. One pair is for receiving and the other pair is for transmitting. The AFE 145 generally includes an analog-to-digital (A/D) converter and a digital-to-analog (D/A) converter.

In the receive direction, signals received by the AFE 145 from the high pass filter 140 are converted from analog to digital by the A/D converter, and are sent to the DSP 150 for processing (e.g., modulation, filtering, and other algorithmic processes). The processed signals can then be provided to the system interface. The AFE 145 may further include a gain adjust module for optimizing the signals sent to the DSP 150.

In the transmit direction, signals from the system interface are received by the DSP 150 and processed (e.g., demodulation, filtering, and other algorithmic processes). The processed signals are converted from digital to analog by the D/A converter in the AFE 145, and sent to the 2-to-4-wire hybrid interface 130 via the line driver 135.

High Pass Filter of ADSL Receive Path—POTS to ADSL Attenuation

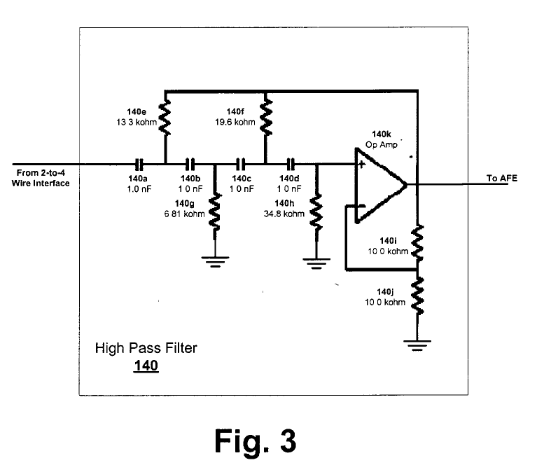

The ADSL modem 105 further includes the receive (RX) path high pass filter 140 for preventing non-ADSL band signals (e.g., POTS signals) from entering into the AFE 145. In one embodiment, high pass filter 140 is a passive, first order high pass filter network. Such a filter allows the signal level in the receive path to be adjusted (attenuated), and generally removes unwanted low frequency signals (e.g., POTS band signals) from the receive path of the DSL circuit. Other conventional high pass filters can be employed here as well, including active and higher order configurations. FIG. 3 illustrates one such alternative embodiment. Here, the filter 140 is configured as an active high pass filter network, and more particularly a fourth order Butterworth filter using a fourth order Sallen-Key topology.

The passband gain of the filter is defined by resistors 140i and 140j, and is two in this particular embodiment. Other gain factors can be employed as well depending on desired performance. The filter network (capacitors 140a-140d and resistors 140e-140h) provides 6 dB of attenuation at 10 kHz, which essentially has four zeros at 0 Hz (DC) and two pairs of complex conjugate poles at 10 kHz. The operational amplifier (op amp) 140k can be any one of a number of conventional op amps. The 741 type will suffice, but higher speed op amps (such as the LM318) tend to increase the filter's performance through increased slew rate and higher unity gain bandwidth. Regardless of its specific type, the op amp's bandwidth is substantially linear through the ADSL frequency band (e.g., about 25 kHz to 1.1 MHz).

Line Driver with Frequency Variant Impedance Synthesis Network

The line driver 135 in the transmit (TX) path provides an active termination, and is configured with a frequency variant impedance synthesis network. This network allows the modem 105 to maintain the desired structural impedances of POTS and ADSL within their operational frequency ranges. The network is frequency variant in that a combination of positive and negative feedbacks are used to synthesize an output impedance (also referred to as the ADSL termination impedance) that appears to be very high (e.g., greater than 1 kohm) at low frequencies (e.g., POTS band frequencies), and approaches 100 ohms at higher frequencies (e.g., ADSL band frequencies). In this sense, the frequency variant impedance synthesis network is disabled at ADSL band frequencies (e.g., at and above 25 kHz) so that an ADSL structural impedance of about 100 ohms is maintained within the ADSL band. The line driver 135 therefore electrically disappears at POTS band frequencies (because of the synthesized high output impedance of the line driver 135), but appears as approximately 100 ohms at ADSL band frequencies thereby allowing the modem 105 to operate at its maximum potential.

Synthesizing the proper ADSL termination impedance reduces the effects of that termination at the POTS band frequencies. In addition, the frequency variant impedance synthesizing network maintains (for POTS band frequencies) a high enough source impedance at the transmission port of the modem 105 so that the POTS structural impedance is maintained for an acceptable, industry standard compliant return loss at the POTS band. The in-line filter 115 effectively isolates the any POTS 120 circuitry from the line at the ADSL band and therefore no additional circuitry is needed to condition the POTS structural impedance. Thus, the use of any POTS 120 is enabled without requiring any modifications to existing POTS circuitry.

Note that there are numerous ways to implement the concepts of the present invention in the context of a DSL communication system. While the functionality of the blocks are maintained from one embodiment to another, the performance or operational characteristics of each block may differ to achieve the same overall circuit performance. The voice circuit and the DSL circuit can be implemented as individual modules as shown (e.g., CO any POTS 120 and ADSL modem 105). However, other configurations will be apparent in light of this disclosure (e.g., a single discrete assembly such as a printed circuit board, or individual integrated circuits or chip sets).

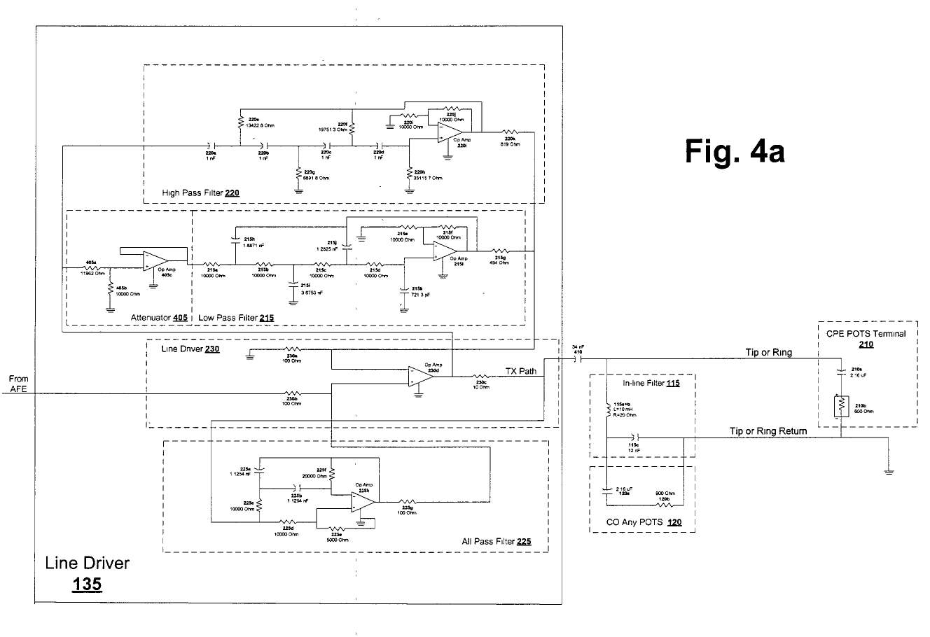

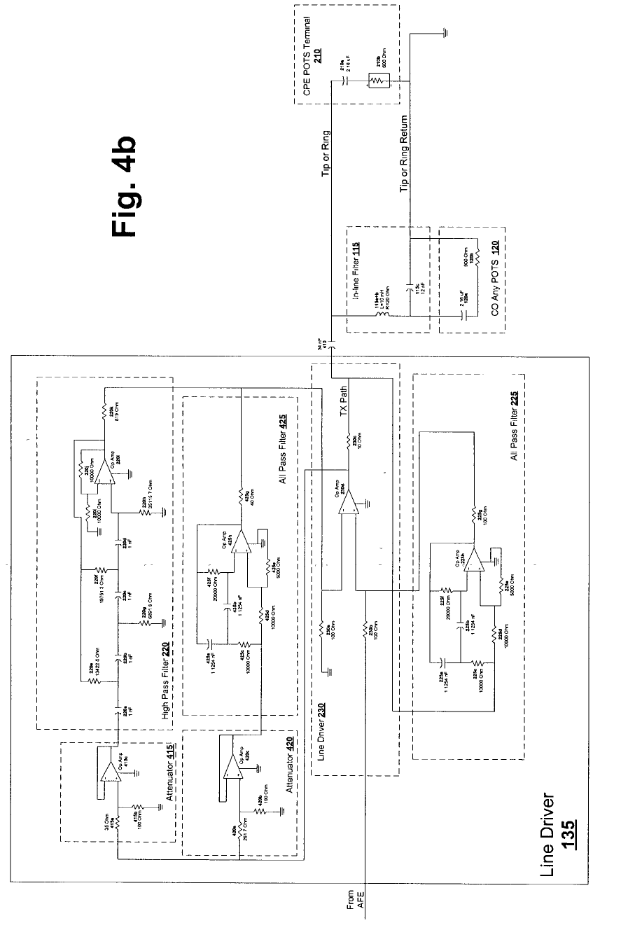

FIG. 2 is a block diagram illustrating the topology of an ADSL line driver and its frequency variant impedance synthesis network in accordance with an embodiment of the present invention. The topology of this embodiment includes a positive feed back path through an all pass filter 225 to the non-inverting input of line driver 230, and a negative feedback path through low pass filter 215 and high pass filter 220 to the inverting input of line driver 230. In an alternative embodiment, the negative feedback path is coupled to the inverting input of line driver 230 through a high pass filter 220 and a second all pass filter. Specific embodiments of the line driver 135 and its frequency variant impedance synthesis network will be discussed in more detail with reference to FIGS. 4a-b.

In general, the frequency variant impedance synthesis can be implemented by manipulating the feedback paths of line driver 135, using a combination of filters (e.g., high pass, low pass, and all pass filters). By introducing a frequency variant source impedance, POTS and ADSL structural impedances are maintained at their rated values so that the reflected power losses can be kept at a minimum at the POTS and ADSL operational frequencies. In such an active termination network, the positive and negative feedback path transfer functions are balanced, both for magnitude and phase characteristics. While the magnitude response is manipulated within the POTS band, its phase characteristics are kept substantially the same. Furthermore, circuit topologies designed in accordance with the principles of the present invention provide substantially similar magnitude and phase responses at the ADSL band to maintain the rated ADSL structural impedance and operational characteristics.

Maintaining balanced phase characteristics between the positive and negative feedback paths of line driver 135, while manipulating the magnitude response of the positive or negative feedback paths, can be accomplished by employing one or more “all pass” filters. In addition, the high pass and the low pass feedback filter networks are configured to achieve previously discussed performance goals. The cutoff frequency of the filters is set at a frequency between the POTS and ADSL frequency bands to have the minimal impact to the POTS and ADSL structural impedances. In one embodiment, the cutoff frequency is approximately 10 kHz.

In general, the cutoff frequency (f) of the filters can be determined by taking the geometric mean of the upper POTS band (e.g., 4 kHz) and lower ADSL upstream band (e.g., 25 kHz) as follows:

f=\sqrt{(4000)(25000)}=10000 Hz.

As previously explained, such a cutoff frequency enables a frequency variant quality that allows structural impedance of the line driver 135 to electrically disappear at POTS band frequencies, but appear as approximately 100 ohms at ADSL band frequencies thereby allowing the modem 105 to operate at its maximum potential (with the POTS and ADSL signal power delivered to the appropriate circuits maximally, minimizing unwanted signal reflection).

High Pass Feedback Path of the Frequency Variant Impedance Synthesis Network

In one embodiment, the high pass filter feedback network 220 of FIG. 2 is a fourth order filter with four zeros at zero and four complex poles at the left half s-plane, having a transfer function, H_{HP}(s):

$${H}_{HP} ( s ) = \frac{{K}_{1} \cdot {s}^{4}}{( s + {p}_{1} ) \cdot ( s + {p}_{2} ) \cdot ( s + {p}_{3} ) \cdot ( s + {p}_{4} )}$$

where p₁=p₂^{*} and p₃=p₄^{*} denotes complex conjugate). K is a scalar which defines the gain of the circuit. Each p is a pole of the function in the complex plane. These poles vary in location based on the desired frequency response and the type of filter being used. A specific embodiment of high pass filter 220 as a fourth order filter is illustrated in FIGS. 4a and 4b.

Assuming the high pass filter 220 has a 10 kHz cutoff frequency, poles of this transfer function are at the following locations on the complex plane:

p₁=−7071.1−j 7071.0;

p₂=−7071.1+j 7071.0;

p₃=−7071.1−j 7071.0; and

p₄=−7071.1+j 7071.0.

Magnitude response, H_{HP}(j ω), of this filter 220 is expressed as:

$$\vert {H}_{HP} ( j ω ) \vert = \frac{{K}_{I} \cdot \vert j {ω}^{4} \vert}{\vert ( j ω + {p}_{1} ) \vert \cdot \vert ( j ω + {p}_{2} ) \vert \cdot \vert ( j ω + {p}_{3} ) \vert \cdot \vert ( j ω + {p}_{4} ) \vert}$$

and the phase response, φ, is given as: φ=+90+90+90+90−θ₁−74 ₂−θ₃−θ₄.

Low Pass Feedback Path of the Frequency Variant Impedance Synthesis Network

In one embodiment, the low pass filter feedback network 215 of FIG. 2 is a fourth order filter with four complex poles at the left half s-plane, having a transfer function, H_{LP}(s):

$${H}_{LP} ( s ) = \frac{{K}_{2}}{( s + {p}_{5} ) \cdot ( s + {p}_{6} ) \cdot ( s + {p}_{7} ) \cdot ( s + {p}_{8} )}$$

where p₅=p₆^{*} and p₇=p₈^{*}. A specific embodiment of low pass filter 215 as a fourth order filter is illustrated in FIG. 4a.

Assuming the low pass filter 215 has a 10 kHz cutoff frequency, poles of this transfer function are at the following locations on the complex plane:

p₅=−7071.1−j 7071.0;

p₆=−7071.1+j 7071.0;

p₇=−7071.1−j 7071.0; and

p₈=−7071.1+j 7071.0.

Magnitude response, H_{LP}(j ω), of this filter 215 is expressed as:

K₂

$$\vert {H}_{LP} ( j ω ) \vert = \frac{}{\vert ( j ω + {p}_{5} ) \vert \cdot \vert ( j ω + {p}_{6} ) \vert \cdot \vert ( j ω + {p}_{7} \vert \cdot \vert ( j ω + {p}_{8} \vert}$$

and the phase response, φ, is given as: φ=−θ₅−θ₆−θ₇−θ₈.

All Pass Feedback Path of the Frequency Variant Impedance Synthesis Network

As illustrated in FIG. 2, the all pass network 225 is coupled to the positive feedback path to compensate for the phase characteristics of the high and low pass feedback filter networks coupled to the negative feedback path. In one embodiment, the all pass filter network 225 has complex poles on the left half s-plane and complex zeros on the right half s-plane, thereby having a flat magnitude response and a phase response determined by the location of its poles and zeros on the complex plane. Its corresponding transfer function, H_{AP}(S), is represented as follows:

$${H}_{AP} ( s ) = \frac{{K}_{3} \cdot ( s + {z}_{1} ) \cdot ( s + {z}_{2} )}{( s + {p}_{1} ) \cdot ( s + {p}_{2} )}$$

where p₁=p₂^{*} and z₂^{*}. Each z represents a zero of the function. A specific embodiment of all pass filter 225 is illustrated in FIGS. 4a and 4b.

Assuming the all pass filter 225 has a 10 kHz cutoff frequency, poles of this transfer function are at the following locations on the complex plane.

p₁=−7071.1−j 7071.0;

p₂=−7071.1+j 7071.0;

z₁=7071.1−j 7071.0; and

z₂=7071.1+j 7071.0.

Magnitude response, H_{AP}(j ω), of this filter 225 is expressed as:

$$\vert {H}_{HP} ( j ω ) \vert = \frac{{K}_{3} \cdot \vert ( j ω + {z}_{1} \vert \cdot \vert ( j ω + {z}_{2} \vert}{\vert ( j ω + {p}_{1} \vert \cdot \vert ( j ω + {p}_{2} \vert}$$

and the phase response, φ, is given as: φ=−θₚ₁−θₚ₂−θ_{z1}−θ_{z2}

Note that this phase response is identical to that of a low pass filter 215 or high pass filter 220 feedback networks of fourth order, as long as both pairs of the complex conjugate poles of the low pass filter network 215 (or high pass filter network 220) are at the same location on the complex plane. Since this embodiment of the all pass filter network 225 has its zeros as the mirror images of its poles on the complex plane, a second order all pass feedback filter network can be employed to provide the identical phase response of the low pass filter network 215 (or high pass filter network 220). For the overall magnitude response, the poles of the all pass feedback filter 225 are compensating for the first pole pair of the low pass filter network 215 (or high pass filter network 220) while the right hand side zeros of the all pass feedback filter 225 are compensating for the other complex pole pair of the low pass filter network 215 (or high pass filter network 220). This is why the complex pole pairs being compensated are in the same location on the complex plane.

### IMPLEMENTATION EXAMPLES

There are multiple possible implementations of the concepts described herein, with various performance levels. The embodiment illustrated in FIG. 4a includes high pass, low pass and all pass filters. An alternative embodiment having two all pass filters and a high pass filter is shown in FIG. 4b. Regardless of the specific implementation and component values, these filters have specific frequency (magnitude and phase) response characteristics as explained herein. Embodiments of the present invention assume that POTS is “any POTS” and that the designer has no access to the any POTS circuitry. It is further assumed that the any POTS has been designed to meet all applicable POTS standards. Therefore, to control the structural impedance of the POTS plus DSL componentry, the two-wire impedance of the ADSL section is manipulated in accordance with the principles of the present invention.

FIG. 4a is a schematic diagram illustrating a line driver with a frequency variant impedance synthesizing network in accordance with one embodiment of the present invention. The line driver 135 can be used to effect a splitterless, transformerless, POTS independent interface between POTS and ADSL circuitry of a central office as illustrated in FIG. 1. In addition, note that an unbalanced circuit is presented in FIG. 4a. However, it will be apparent to one skilled in the art that an actual implementation would provide a differential configuration having two such circuits to provide the requisite balance.

The line driver 135, which is configured with an active termination, includes a driver 230 having a negative feed back path and a positive feedback path. The negative feedback path includes low pass filter 215, high pass filter 220, and attenuator 405. The positive feedback path includes all pass filter 225. In order to synthesize the appropriate DSL termination impedance, the line driver 135 has a frequency dependent positive and negative feedback paths. The positive feedback path has flat frequency response and the all pass filter 225 is employed for maintaining phase characteristics as previously described, which provides an identical phase response on the negative feedback path. The all pass filter 225, which includes op amp 225h, capacitors 225a and 225b, and resistors 225c-g, has complex poles on the left half s-plane and complex zeros on the right half s-plane.

The high pass filter 220 and low pass filter 215 in the negative feedback path determine the frequency boundaries for the synthesized termination impedance. The cut off frequency for each of the filters for this particular embodiment has been calculated as the geometric mean of 25 kHz and 4 kHz and is equal to 10 kHz. The high pass filter 220, which includes op amp 2201, capacitors 220a-d, and resistors 220e-k, is a fourth order filter with four zeros at zero and four complex poles at the left half s-plane. This filter 220 is similar in design to the high pass filter 140 illustrated in FIG. 3. The low pass filter 215, which includes op amp 2151, resistors 215a-g, and capacitors 215h-k, is a fourth order filter with four complex poles at the left half s-plane.

The line driver 135 synthesizes 100 ohms (e.g., +/−30 ohms) termination impedance across the ADSL band (e.g., 25 kHz to 1.2 MHz). However, the ADSL termination impedance synthesized by line driver 135 for the POTS band (e.g., up to 4 kHz) is higher than 1 kohm. This relatively high termination impedance (as compared to 200 ohms and less) reduces the shunting effect of the ADSL two-wire impedance on the any POTS 120 two-wire impedance, and improves the return loss characteristics of the overall circuit.

Attenuator 405 includes a voltage divider provided by resistors 405a and 405b and an op amp 405c configured as a voltage follower. The attenuation factor provided by this embodiment is approximately 0.455. The attenuator 405 and resistors 215g and 220k set the gain and the output impedance in the ADSL and POTS frequency bands independently. In this sense, attenuator 405 acts as both a POTS band attenuator and a DSL band attenuator. The phase response of the negative and positive feedback paths is substantially identical (e.g., within +/−10 percent of one another). The output impedance of the circuit is about 100 ohms of resistance plus a 34 nF capacitor (capacitor 410), which is the standard output impedance of ADSL circuitry.

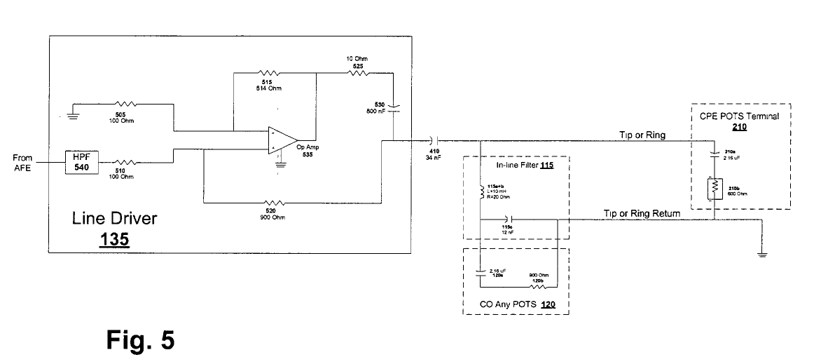

The op amps 2151, 2201, 230d, 225h, and 405c can be any one of a number of conventional op amps (e.g., LM318). Regardless of its specific type, the op amp's bandwidth is substantially linear through the ADSL frequency band (e.g., about 25 kHz to 1.1 MHz). This is generally true of the op amps illustrated in FIGS. 4b and 5 as well.

FIG. 4b is a schematic diagram illustrating a line driver with a frequency variant impedance synthesizing network in accordance with another embodiment of the present invention. The discussion with reference to FIG. 4a equally applies to the circuit of FIG. 4b, with the differences relevant to the FIG. 4b circuit discussed here. At POTS band frequencies, the impedance synthesis for the POTS band is provided by two similarly configured all pass filters 425 and 225 in negative and positive feedback paths, respectively. The effect of the high pass filter 220 at POTS band frequencies is negligible. At ADSL band frequencies, however, the negative feedback increases due to the high pass filter 220 thereby decreasing the output impedance of the line driver 135 to a nominal value of about 100 Ohms.

The adjustment of output impedance for POTS and ADSL band is performed independently by corresponding attenuators 415 and 420. In particular, DSL band attenuator 415, which includes op amp 415c and resistors 415a and 415b, provides an attenuation factor of 0.741 to the ADSL band impedance, and POTS band attenuator 420, which includes op amp 420c and resistors 420a and 420b, provides an attenuation factor of 0.276 to the POTS band impedance.

Note that this circuitry has less components sensitive to value change than the circuit of FIG. 4a. In addition, the circuitry provides high predictability in the POTS band impedance because the two similarly configured all pass filters 225 and 425 (for synthesizing impedance in POTS band) have substantially identical frequency and phase responses (e.g., +/−10%).

FIG. 5 is a schematic diagram illustrating a line driver with a frequency variant impedance synthesizing network in accordance with another embodiment of the present invention. Again, note that an unbalanced circuit is presented in FIG. 5, and that an actual implementation would provide a differential configuration having two such circuits to provide the requisite balance.

The concept behind this implementation is to simplify the circuitry of FIGS. 4a and 4b while achieving the same function: to synthesize an output impedance which is approximately 100 ohms at ADSL band frequencies, and a relatively high output impedance at POTS band frequencies. The relatively higher output impedance at POTS band frequencies minimizes the impact of the line driver 135 on the POTS band structural impedance. In this sense, the relatively higher output impedance at POTS band frequencies allows the line driver 135 to electrically disappear.

In this embodiment, the line driver 135 includes op amp 535, resistors 505 to 525, and capacitor 530, and is configured to synthesize a capacitor in addition to a resistor. With such a configuration, the output impedance of the ADSL circuitry increases as frequency decreases in accordance with the principles of the present invention. Capacitor 530 and resistors 520 and 525 are provided in the positive feedback loop to synthesize the desired capacitor and resistor of the any POTS 120. The first order filter formed by capacitor 530 feed back resistors 520 and 525 allows this configuration of line driver 135 to be frequency variant as described in reference to the embodiments of FIGS. 4a and 4b.

Note that this alternative embodiment may further include an additional high pass filter (HPF) 540 on the non-inverting input to improve the attenuation of POTS band signals. This filter 540 will prevent overload of the ADSL receive port of the line driver 135 (e.g., the input from the AFE). In one embodiment, filter 540 is configured as the fourth order high pass filter discussed in reference to FIG. 3. Other high pass filter configurations can be used here as well.

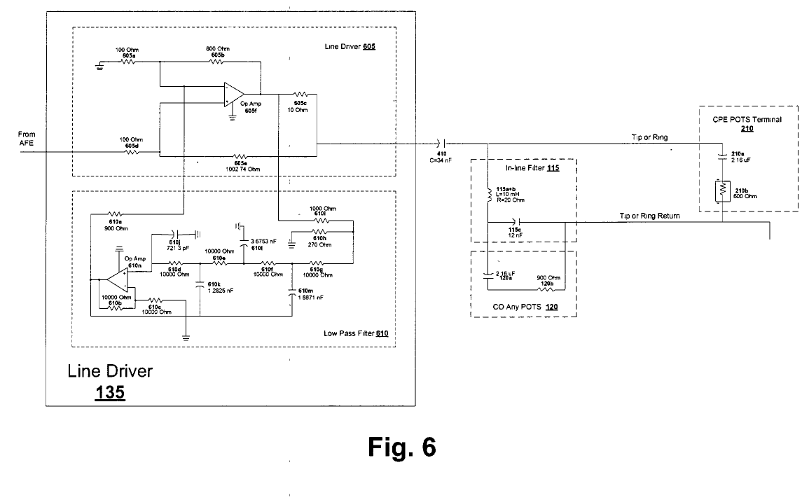

FIG. 6 is a schematic diagram illustrating a line driver with a frequency variant impedance synthesizing network in accordance with another embodiment of the present invention. Again, note that an unbalanced circuit is presented in FIG. 6, and that an actual implementation would provide a differential configuration having two such circuits to provide the requisite balance. This embodiment achieves the same function as the embodiments illustrated in FIGS. 4a, 4b, and 5: to synthesize an output impedance which is approximately 100 ohms at ADSL band frequencies, and a relatively high output impedance at POTS band frequencies.

In this embodiment, the line driver 135 includes a driver 605 having positive and negative feedbacks, where the negative feedback includes a low pass filter network 610. Driver 605 includes an op amp 605f and resistors 605a to 605e. The low pass filter 610 includes op amp 610n resistors 610a to 610i, and capacitors 610j to 610m. Generally, the output or termination impedance of the line driver 135 in the POTS band is determined by the ratio of positive feedback gain to negative feedback.

In the POTS frequency band, gain in the negative feedback depends on transmission characteristics of the low pass filter 610. In the DSL band, the gain is a function of resistors 605a, 605b, and 610a. In accordance with the principles of the present invention, the different characteristics of negative feedback in the POTS and DSL bands allow two different DSL termination impedances to be synthesized: one is high (e.g., greater than 1 kohm) for POTS band frequencies and under 200 ohms (e.g., about 100 ohms) for DSL band frequencies.

The foregoing description of the embodiments of the invention has been presented for the purposes of illustration and description. It is not intended to be exhaustive or to limit the invention to the precise form disclosed. Many modifications and variations are possible in light of this disclosure. For example, it will be apparent from this disclosure that the present invention is not intended to be limited to POTS, but can be applied to other voice services such as Special Services as well (e.g., Foreign Exchange Subscriber (FXS)). Numerous such voice processing applications and corresponding voice circuitry can be combined with a DSL application in accordance with the principles of the present invention. Voice and DSL structural impedances are maintained at their rated values so that the reflected power losses can be kept at a minimum at the voice and DSL operational frequencies. It is intended that the scope of the invention be limited not by this detailed description, but rather by the claims appended hereto.

What is claimed is:

1. A system for interfacing a telephone line with a central office, the system comprising:
an any POTS circuit having a two-wire interface, the any POTS circuit for processing POTS signals;
in-line filter operatively coupled to a data path between the telephone line and the any POTS circuit, the in-line filter having a capacitor that is coupled across the two-wire interface of the any POTS circuit, the in-line filter for rejecting signals having frequencies above the POTS frequency band; and
a DSL circuit operatively coupled to the telephone line, and having a transmit path line driver configured with a frequency variant impedance synthesis network for actively synthesizing a DSL termination impedance that increases in magnitude with decreasing frequency, the DSL circuit for processing DSL signals.

2. The system of claim 1 wherein the in-line filter further includes two inductors that are serially coupled to the data path.

3. The system of claim 1 wherein the frequency variant impedance synthesis network includes one or more feedbacks, and the synthesized DSL termination impedance is greater than 1 kohm at POTS band frequencies and between 80 and 120 ohms at DSL band frequencies.

4. The system of claim 1 wherein the frequency variant impedance synthesis network includes one or more feedback filters that determine frequency boundaries of the synthesized DSL termination impedance, where the synthesized DSL termination impedance is greater than 1 kohm at POTS band frequencies and between 80 and 120 ohms at DSL band frequencies.

5. The system of claim 1 wherein the frequency variant impedance synthesis network includes one or more feedback filters that compensate for phase characteristics of other feedback filters included in the network.

6. The system of claim 1 wherein the DSL circuit has a receive path high pass filter for removing unwanted low frequency signals from the DSL circuit's receive path.

7. The system of claim 1 further comprising:
a DC blocking mechanism operatively coupled to the DSL circuit for isolating the DSL circuit from DC signals.

8. The system of claim 7 wherein the DC blocking mechanism includes two serial capacitors that provide a total capacitance of 30 to 36 nanofarads.

9. The system of claim 1 further comprising:
a protection block operatively coupled between the telephone line and both the in-line filter and the DSL circuit, the protection block for protecting against at least one of power cross and high voltage surges.

10. A system for interfacing a telephone line with a central office, the system having no bulky splitter, and comprising:
in-line filter adapted to couple to a data path between the telephone line and an any voice circuit having a two-wire interface, the in-line filter having a capacitor that couples across the two-wire interface of the any voice circuit, the in-line filter for rejecting signals having frequencies above the voice frequency band; and
an ADSL circuit operatively adapted to couple with the telephone line, and having a transmit path line driver configured with a frequency variant impedance synthesis network including one or more feedbacks that that allow the line driver to actively synthesize an ADSL termination impedance that is greater than 1 kohm at voice band frequencies and less than 200 ohms at ADSL band frequencies, the ADSL circuit for processing DSL signals.

11. The system of claim 10 wherein the ADSL circuit has a receive path high pass filter for removing unwanted low frequency signals from the ADSL circuit's receive path.

12. The system of claim 10 wherein the frequency variant impedance synthesis network includes a positive feedback all pass filter that compensates for phase characteristics of negative feedback filters included in the network.

13. The system of claim 12 wherein the negative feedback filters include a high pass filter and a low pass filter that determine frequency boundaries of the synthesized ADSL termination impedance.

14. The system of claim 12 wherein the negative feedback filters include a high pass filter having a negligible effect at voice band frequencies, and an all pass filter that has substantially identical frequency and phase responses to the positive feedback all pass filter.

15. A transmit path ADSL line driver device configured to actively synthesize a desired ADSL termination impedance, and for use in a central office interface that has no bulky splitter and no DSL coupling transformer, the device comprising:
one or more negative feedback filters defining frequency boundaries of synthesized ADSL termination impedance, where the synthesized ADSL termination impedance is greater than 1 kohm at voice band frequencies and less than 200 ohms at ADSL band frequencies; and
a positive feedback filter that compensates for phase characteristics of the negative feedback filters.

16. The device of claim 15 further including a voice band attenuator operatively coupled to one of the negative feed back filters, the voice band attenuator for setting gain at voice band frequencies.

17. The device of claim 15 further including an ADSL band attenuator operatively coupled to one of the negative feed back filters, the ADSL band attenuator for setting gain at ADSL band frequencies.

18. A transmit path ADSL line driver device configured to actively synthesize a desired ADSL termination impedance, and for use in a central office interface that has no bulky splitter and no DSL coupling transformer, the device comprising:
a first operational amplifier for driving transmit signals on a first wire pair included in a 4-wire interface;
a second operational amplifier for driving transmit signals on a second wire pair included in the 4-wire interface;
wherein each of the first and second operational amplifiers has a frequency variant impedance synthesis network including one or more feedbacks that that allow the device to actively synthesize an ADSL termination impedance that is greater than 1 kohm at voice band frequencies and less than 200 ohms at ADSL band frequencies.

19. The device of claim 18 wherein each of the first and second operational amplifiers has operatively coupled to its input a high pass filter for preventing overload of DSL receive ports of the device.

20. The device of claim 18 wherein the frequency variant impedance synthesis network includes a positive feedback all pass filter that compensates for phase characteristics of negative feedback filters included in the network.

21. The device of claim 20 wherein the negative feedback filters include a high pass filter and a low pass filter that determine frequency boundaries of the synthesized ADSL termination impedance.

22. The system of claim 20 wherein the negative feedback filters include a high pass filter having a negligible effect at voice band frequencies, and an all pass filter that has substantially identical frequency and phase responses to the positive feedback all pass filter.

23. The device of claim 18 wherein the frequency variant impedance synthesis network includes a negative feedback low pass filter.

24. The device of claim 18 wherein the frequency variant impedance synthesis network includes a negative feedback all pass filter.

25. The device of claim 18 wherein the frequency variant impedance synthesis network includes a negative feedback high pass filter.
